(19) United States
(12) Patent Application Publication
(10) Pub. No.: US 2024/0266706 A1
(43) Pub. Date: Aug. 8, 2024

(54) DATA COMMUNICATION LINE AND CONNECTOR

(71) Applicant: SAMTEC, INC., New Albany, IN (US)

(72) Inventors: Marc EPITAUX, New Albany, IN (US); Thomas Albert HALL, III, New Albany, IN (US)

(21) Appl. No.: 18/566,363

(22) PCT Filed: Jun. 3, 2022
(86) PCT No.: PCT/US2022/032191

§ 371 Date: Dec. 1, 2023

Related U.S. Application Data
(60) Provisional application No. 63/196,345, filed on Jun. 3, 2021.

(51) Int. Cl. H01P 3/16

(52) U.S. Cl. CPC H01P 3/16

(57) ABSTRACT

A data communication connector can include a dielectric waveguide that extends along a central axis, and a recess that is configured to receive an antenna. The data communication connector can include an electrically conductive body that receives the dielectric waveguide. The electrically conductive body can define the recess. The dielectric waveguide can include a dielectric core, a ground shield, and a jacket.

### CROSS-REFERENCE TO RELATED APPLICATIONS

This application claims priority to U.S. provisional patent application No. 63/196,345 filed Jun. 3, 2021, the disclosure of which is hereby incorporated by reference as if set forth in their entirety herein.

### FIELD OF THE INVENTION

The present disclosure relates to data communication lines and, more particularly, to dielectric waveguides.

### BACKGROUND

Electromagnetic energy in the approximately 10 to 300 GHz frequency region may be transmitted through a variety of structures. This frequency region is often referred to as a millimeter-wave region, since an electromagnetic wave propagating in free space has a wavelength that varies from 1 mm at 300 GHz to 30 mm at 10 GHz. One type of transmission structure for electromagnetic wave propagation is a metallic dielectric waveguide. The waveguide can include a dielectric core, ground shield, and jacket, sometimes referred to as a metallic dielectric waveguide (MDkWG) cable. Existing interconnections between the MDKWG cable and an electrical element or other waveguide structures can have undesirable transmission loss Therefore, there is a need for an improved interconnection to metallic dielectric waveguide cables.

### SUMMARY OF INVENTION

In one embodiment, a data communication connector comprises a dielectric waveguide that extends along a central axis, and a hole that is configured to receive an antenna. The hole can include a first end and a second end spaced from the first end along a hole axis, the hole axis being transverse to the central axis. The hole axis can intersect the central axis at an angle of about 75 degrees to about 105 degrees.

In a further embodiment, a data communication connector includes an electrically conductive body that receives the dielectric waveguide, the electrically conductive body defining the hole. The electrically conductive body can include an opening and the dielectric waveguide can be positioned within the opening. The electrically conductive body can include a body first end and a body second end spaced from the body first end along a body axis. The opening can extend from the body first end toward the body second end. The electrically conductive body can include an endwall defining an end of the opening. The hole axis can intersect the opening between the body first end and the endwall. The dielectric waveguide can include a dielectric core. The dielectric waveguide can include a ground shield surrounding at least a portion of the dielectric core.

In a further embodiment, the data communication connector includes an antenna with a portion of the antenna can be situated in the hole. The connector can be configured to propagate an electromagnetic signal. The connector can be configured to propagate an electromagnetic signal within a frequency range between 10 GHz and 300 GHz. The electrically conductive body can be fixed to the dielectric waveguide. The dielectric waveguide can be a metallic dielectric waveguide cable. The metallic dielectric waveguide cable can include the ground shield and the electrically conductive body electrically coupled to the ground shield. The connector can be configured to propagate an electromagnetic signal. A distance between the endwall and the hole axis can be one quarter of a wavelength of the electromagnetic signal. A dielectric bead can surround at least a portion of the antenna. The ground shield can envelop a first portion of the dielectric core. The ground shield may not envelop a second portion of the dielectric core.

In another embodiment, an interconnection system includes the data communication connector and a jack configured to be fixedly mounted to a substrate. The jack can include a conductor, an insulator, and a threaded outer body. The electrically conductive body can be configured to be fixed to a substrate. The electrically conductive body can include external threads extending along the longitudinal direction. A first end of the antenna can terminate in the antenna hole at a depth near a mid-point of the dielectric core in the transverse direction. The ground shield can include a channel aligned with the hole.

In another embodiment, an interconnection system can include a connector and a data communication line butted against the connector.

A method of terminating an end of a data communication line having a core, a ground shield, and a jacket enveloping the ground shield and the core can include removing a portion of the jacket to expose a portion of the ground and removing a portion of the ground shield to expose a portion of the core. The method can include drilling an antenna hole through the exposed portion of the core. The method can include applying a solder preform to the exposed portion of the ground shield. The method can include placing an end of the data communication line into an opening in an electrically conductive body.

In a further embodiment, the method includes soldering the electrically conductive body to the ground shield. The method can include inserting an antenna and a dielectric bead into the hole. The data communication line can include a first end and a second end spaced from the first end along a central axis and the antenna can include a first antenna end and a second antenna end spaced from the first antenna end along an antenna central axis transverse to the central axis. The hole can be a through hole. In another embodiment, the hole can be a blind hole.

In another embodiment, a data communication line extends in a longitudinal direction having a first and second end. The data communication line can include a dielectric core, a ground shield surrounding the dielectric core, a jacket surrounding the ground shield. The data communication line can further include an alignment ferrule coupled to the ground shield. The alignment ferrule can be coupled to the ground shield at the first end of the data communication line. An end of each of the dielectric core, the ground shield, and the alignment ferrule define a substantially planar face at the first end of the data communication line. The data communication line can be a metallic dielectric waveguide cable. The data communication line can include a nut on the first end of the data communication line. The dielectric core can have a structure selected from a group consisting of a solid, a foam, a hollow tube, and a tube with an internal structure. The data communication line can be configured to propagate an electromagnetic signal within a of about 10 GHz to about 300 GHz.

In another embodiment, an adaptor includes an insert assembly configured to transition between a dielectric waveguide cable and a tube waveguide. The dielectric waveguide cable and the tube waveguide each define a signal propagation path that extends in a longitudinal direction. In a further embodiment, the adaptor includes a flange having a first side and a second side spaced from the first side along the longitudinal direction, the flange including a flange opening extending from the first side to the second side. The insert assembly can include a shield plug positioned in the flange opening, the shield plug having a shield plug through hole, and a dielectric insert positioned in the shield plug through hole. The dielectric insert can include a first end and a second end spaced from the first end along the longitudinal direction, and the dielectric insert tapers inwardly toward the second end. A cross-section of the dielectric insert substantially matches a cross-section of the dielectric waveguide cable on the first side of the flange. The shield plug can include a sidewall defining the shield plug through hole and the sidewall tapers outwardly toward the second end of the flange.

In another embodiment, a method of transmitting an electromagnetic signal through a data communication line having a first end and opposed second end can include sending the electromagnetic signal through a first antenna, propagating the electromagnetic single through the data communication line, and receiving the electromagnetic signal at a second antenna. The data communication line can be a metallic dielectric waveguide cable. The first antenna can be located at the first end of a continuous metallic dielectric waveguide cable. The second antenna can be located at the second end of the data communication line. The data communication line can include a dielectric core. The first antenna can be inserted in a first antenna hole in the dielectric core. The first antenna hole can be located at the first end of the data communication line. The second antenna can be inserted in a second antenna hole in the dielectric core. The second antenna hole can be located at the second end of the data communication line.

### BRIEF DESCRIPTION OF THE FIGURES

The foregoing summary, as well as the following detailed description of embodiments of the application, will be better understood when read in conjunction with the appended drawings. For the purposes of illustrating the methods and devices of the present application, there is shown in the drawings representative embodiments. It should be understood, however, that the application is not limited to the precise methods and devices shown. In the drawings:

FIG. 1 is an isometric view of a mated connector according to an embodiment of the disclosure;

FIG. 2 is a cross-sectional view of the connector depicted in FIG. 1;

FIG. 3 is a cross-sectional view of the connector depicted in FIG. 1 mated to a jack;

FIGS. 4A-4E are top plan views of a data communication line in various stages of assembly;

FIG. 5 is a flow chart describing a method of assembling a data communication line;

FIG. 6 is a sectional view of a connector mounted to a substrate according to an embodiment of the disclosure;

FIG. 7 is an isometric view of the connector of FIG. 6 and a data communication line;

FIG. 8 is a sectional view of the data communication line of FIG. 7;

FIG. 9 is an isometric view of an alignment ferrule according to an embodiment of the disclosure;

FIG. 10 is an isometric view of the data communication line of FIG. 8 and an adaptor flange according to an embodiment of the disclosure;

FIG. 11 is a sectional view of the adaptor flange shown in FIG. 10;

FIG. 12 is a sectional view of the adaptor flange shown in FIG. 10; and

FIG. 13 is an isometric view of an insert according to an embodiment of the disclosure.

### DETAILED DESCRIPTION

The embodiments described herein disclose an interconnection system and method having a low transmission loss and minimal reflection of the propagating signal. The signal can be an optical signal. Additionally, the interconnection is compact, easy to connect and disconnect, and maintains good signal integrity. The embodiments can be used in any application to propagate a millimeter-wave signal between two points.

An interconnection system may be designed to operate at any desired frequency. For example, an interconnection system may be designed to operate at a frequency range from 10 GHz to 300 GHz. This frequency range is commonly divided into various frequency bands, denoted by letters, such as the U-band, V-band, W-band, and others. The interconnection system may be designed to operate in the W-band at about 75 GHz to 110 GHz, corresponding to free space wavelength range of approximately 2.7 to 4 mm. A data communication line assembly can have an effective dielectric constant of 1.5 which provides a propagating wavelength for signals in a W-band cable of between approximately 1.8 mm and 2.67 mm. Interconnection systems can include various components which can be designed to minimize or eliminate signal degradation at the transitions between the various components.

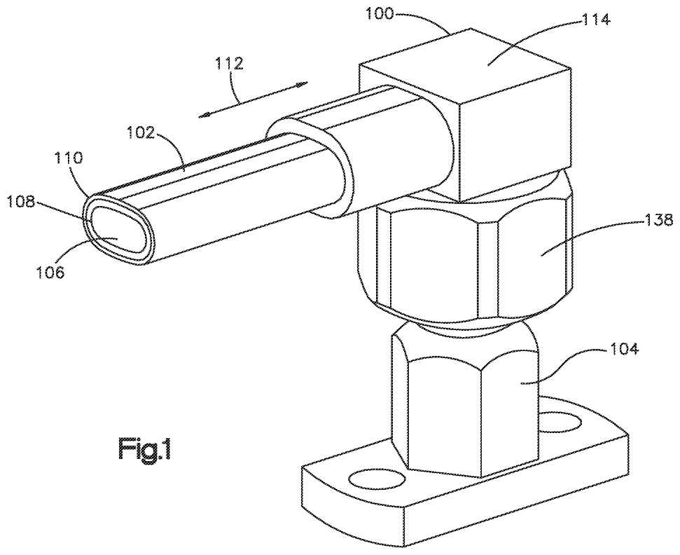

FIG. 1 shows a connector 100 which can provide an interconnection between a data communication line 102 and a jack 104. The jack 104 can be coupled to a substrate (not shown in FIG. 1). The substrate can be a printed circuit board. The jack 104 may be a standard commercially available component, such as an IEEE STD 287 1.0 mm connector jack available from Southwest Microwave located in Tempe, AZ.

The data communication line 102 can be a cable. The data communication line 102 can be a dielectric waveguide. The data communication line 102 can be a waveguide cable. The data communication line 102 can be a dielectric waveguide cable. The data communication line 102 can be made from a metallic material. The data communication line 102 can be a metallic dielectric waveguide cable. A portion of the data communication line 102 can extend in a longitudinal direction 112. The data communication line 102 can be elongate along a central axis. The data communication line 102 can include a first end and a second end spaced from the first end along a central axis. The central axis can be parallel to the longitudinal direction 112. The data communication line 102 can define an oval cross-sectional shape taken along a plane perpendicular to the central axis. The data communication line 102 can be devoid of a signal conductor.

The connector 100 can be coupled to an end of the data communication line 102. The data communication line 102 can include a core 106. The core 106 may be formed from a dielectric material. The core 106 may be a solid core, a hollow core, or a foam core, consisting of random small voids dispersed throughout the dielectric core. The core 106 may also be formed by a longitudinally extended dielectric structure as depicted in FIG. 1. The core 106 may be a longitudinally extended dielectric structure with an internal void. The core 106 can include two, three, four, five, or six voids. In some embodiments, the core 106 may include two or more voids that extend from the first end to the second end of the core 106. The internal voids can have a substantially uniform cross-section along the length of the core. In some embodiments, the internal voids each have a similar cross-sectional shape and cross-sectional area. In other embodiments, the cross-sectional shape of one void is different from the cross-sectional shape of another void. In some embodiments, the cross-sectional area of one void is different from the cross-sectional area of another void. A core with an internal void may be referred to as a tube with an internal structure. The data communication line 102 can be devoid of a signal conductor inside the core 106.

The core 106 may be formed from a polymer. to the polymer can be, for example, polytetrafluoroethylene, perfluoroalkoxy alkane, or polyolefin. The material choice may be based in part on using a material that has a low loss tangent for signal frequencies in a design operating range. The loss tangent is a ratio of the lossy reaction to the lossless reaction of the material to an applied electric field. Materials having a low loss tangent have lower propagation losses that materials with a high loss tangent. The core 106 may be manufactured from a material with a low dielectric constant. The dielectric constant can influence the impedance of the cable. The impedance may be tuned by including voids to obtain a lower net effective dielectric constant. In some embodiments, the voids can have a small irregular shape. In other embodiments, the voids can have a uniform, longitudinally extended shape. to the core 106 The internal structure of the core 106 may be tuned to achieve a desired impedance, which may help to minimize signal insertion or reflection losses at junctions in a system using the data communication line 102. Mechanical characteristics may also influence the material choice for the core 106. Flammability, tensile strength, processability may be factors considered when specifying the material.

The data communication line can include an electrically conductive ground shield 108. The ground shield 108 can abut at least a portion of the core 106. The ground shield 108 can envelop a first portion of the core 106. A second portion of the core may not be enveloped by the ground shield 108. The ground shield 108 can surround the core 106. The ground shield 108 can surround a perimeter of the core 106 when viewed in a cross-section along a plane perpendicular to the longitudinal direction 112. The ground shield 108 may be an electrically conductive material. The ground shield 108 may be a braid of electrically conductive wire, an electrically conductive coating applied to the core 106, or an electrically conductive foil wrapped around the core 106. The type of ground shield 108 used may vary depending on the desired cable flexibility. A jacket 110 can abut the ground shield 108. The ground shield 108 can be positioned between the jacket 110 and the core 106. The jacket can provide mechanical protection for the ground shield 108 and core 106. The jacket 110 may limit flexibility of the data communication line 102 to ensure a minimum bend radius to avoid excessive propagation loss of millimeter waves propagating in the data communication line 102.

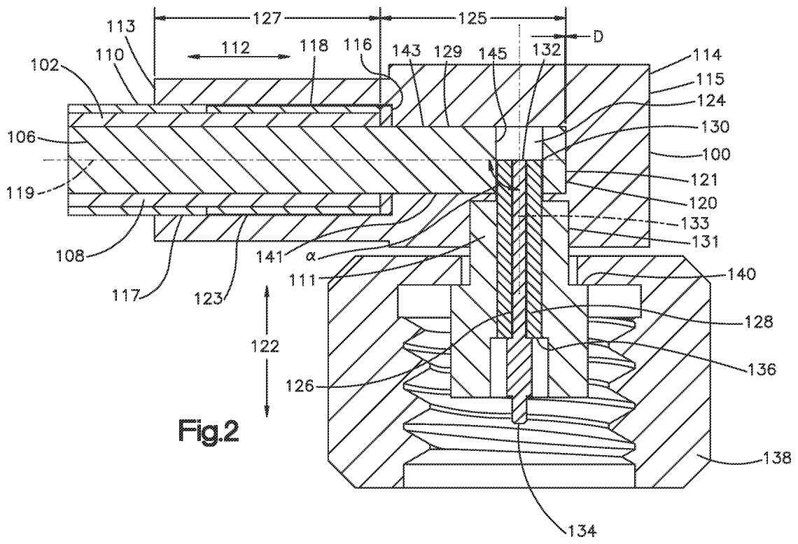

FIG. 2 shows a cross-sectional view of the connector 100 depicted in FIG. 1. The connector 100 can include a body 114 including a first end 113 and a second end 115. The second end 115 can be spaced from the first end along a body axis. The body axis can be parallel to the longitudinal axis 112. The body axis can intersect the transverse axis that extends in the transverse direction 122. The transverse axis may intersect the central axis of the data communication line 102. The transverse axis may be perpendicular to the central axis of the data communication line 102. The body axis can be perpendicular to the transverse axis. The body axis can be coaxial with the central axis of the data communication line 102. The data communication line 102 can be fixed to the body 114.

The core 106 can be disposed within the body 114. The body 114 can include an opening 117 that extends from the first end 113 toward the second end 115. At least a portion of the data communication line 102 can be positioned in the opening. The body 114 can be adapted to receive a portion of the data communication line 102. The opening can be disposed about an opening central axis 119. In some embodiments, the opening central axis 119 can be parallel to the longitudinal axis 112. In other embodiments, the opening central axis 119 can be transverse to the longitudinal axis 112. An endwall 121 can be positioned at an end of the opening 117. The endwall 121 can be positioned opposite the first end 113 of the body 114 along the body axis.

The body 114 may be fabricated from an electrically conductive material. The body 114 can be fabricated from passivated stainless steel or gold-plated brass. An electrically conductive body 114 provides an endwall 121 that effectively provides an electrical short, known as a back short, at an end 120 of the data communication line 102 when the data communication line 102 is positioned in the opening 117. The back short can reflect an alternating signal within the data communication line 102 into a standing wave pattern so that the signal will be injected into the data communication line 102 with minimal degradation.

The opening 117 can include a first section 123 having a first cross-sectional dimension taken along a first plane perpendicular to the opening central axis 119. The opening 117 can include a second section 129 with a second cross-sectional dimension taken along the first plane. The second cross-sectional dimension can be smaller than the first cross-sectional dimension. The transition from the first portion 123 to the second portion 129 can be defined by a step 116. The first cross-sectional dimension can be selected such that the first portion 123 can receive the core 106, the ground shield 108, and the jacket 110 of the first end of the data communication line 102. A portion of the jacket 110 can be removed from the end of the data communication line 102 such that a portion of the ground shield 108 is exposed prior to positioning the end of the data communication line in the opening 117. Solder 118 may provide a mechanical and electrical connection between the ground shield 108 and the body 114 within the opening 117. The ground shield 108 can extend to an end of the first portion 123 of the opening 117.

The core 106 may define the end 120 of the data communication line 102. In some embodiments, the core 106 extends to the endwall 121 of the body 114. The line end 120 may contact the endwall. The ground shield 108 may terminate prior to the line end 120 such that it does not surround a second portion 125 of the core 106. The ground shield 108 may surround a first portion 127 of the core 106 located farther away from the line end 120 than the second portion 125. The core 106 may be positioned within the second portion 129 of the opening 117. The core 106 may be the only portion of the data communication line 102 within the second portion 129 of the opening.

The body 114 may include a second opening 131 that extends from a first end to a second end along a second opening central axis 133. The second opening central axis 133 can be oriented in a transverse direction 122 perpendicular to the longitudinal direction 112. The second opening central axis 133 can be transverse to the opening central axis 119. The second opening central axis 133 can be perpendicular to the opening central axis 119. The second opening central axis 133 can be disposed at an angle α relative to the opening central axis 119. The angle α can be about 1 degree to about 15 degrees, about 15 degrees to about 30 degrees, about 30 degrees to about 45 degrees, about 45 degrees to about 60 degrees, about 60 degrees to about 75 degrees, or about 70 degrees to about 90 degrees. The second opening 131 can extend to the opening 117 such that the openings form a continuous path through the body 114.

The core 106 can include a first side 141 and a second side 143. The second side 143 can be spaced from the first side 141 along the transverse direction. The transverse direction can be angularly offset with respect to the central axis. The core 106 may have a recess 124. The recess 124 can extend from the first side 141 toward the second side 143. The first side 141 can be spaced from the second side 143 along a recess axis. The recess axis can be transverse to the central axis of the core 106. The recess axis can intersect the central axis of the core 106. The recess axis can extend in the transverse direction 122 when the data communication line 102 is within the opening 117. The recess axis 133 can be disposed at an angle α relative to the opening central axis 119. The angle α can be about 1 degree to about 15 degrees, about 15 degrees to about 30 degrees, about 30 degrees to about 45 degrees, about 45 degrees to about 60 degrees, about 60 degrees to about 75 degrees, or about 70 degrees to about 90 degrees.

In some embodiments, the recess 124 may be located in the second portion 125 of the core 106 that is not surrounded by the ground shield 108. In other embodiments, the recess 124 can be located in the first portion 127 of the core 106. In some embodiments, the recess 124 may be a through hole extending completely through the core 106. In other embodiments, the recess 124 may extend through only a portion of the core 106. The recess 124 may be a through hole. The recess 124 may be a blind hole. The recess 124 can have a selected cross-sectional shape. For example, a cross-sectional shape of the recess 124 can be a triangle, semi-circle, hemi-circle, arced, or square. triangular, circle, arced, or square shape. The cross-section may be taken along a plane perpendicular to the longitudinal direction 112. The recess 124 can extend through each of first side 141 and second side 143. The core 106 may define an outer perimeter that is discontinuous at the first side 141 so as to define first and second terminal ends of the outer perimeter that line on the plane defined by the first side 141.

The recess 124 may be defined by a sidewall 145 that extends from the first side 141 toward the second side 143. The recess 124 may include an end extending from the sidewall 145 that defines an end of the recess 124. The end wall may be generally perpendicular to the sidewall 145. The recess 124 may extend from the first side 141 toward the second side 143. The recess 124 may extend from the first side 141 to the second side 143.

The recess 124 can be adapted to receive a portion of a communication element 126. The communication element 126 can be an antenna or connector pin. The communication element 126 can be positioned in the recess 124 such that the communication element is spaced from the sidewall 145. The communication element 126 can contact the endwall of the recess 124. The communication element 126 may be substantially centered in the recess 124. The communication element 126 can extend through each of the first side 141 and the second side 143 of the core 106. The communication element 126 can extend through the first side 141 of the core 106. The communication element 126 may not extend through the second side 143 of the core 106. The recess 124 can be formed by inserting the communication element 126 into the core 106. The present disclosure can include a dielectric waveguide with an antenna inserted therein. The core 106 can be penetrated by the communication element 126. A surface of the core 106 can be penetrated by the communication element so as to define the recess 124. The core 106 can be devoid of the ground shield 108 that the communication element 126 is inserted into the core 106 without an electrical shield.

The communication element 126 may include a first end 132 and a second end 134 spaced from the first end 132 along a communication element central axis. The central axis may be parallel to the second opening central axis 133. The communication element central axis may be parallel to the transverse direction 122. The communication element central axis may be coaxial with the second opening central axis 133. The first end 132 of the communication element 126 may be positioned in the recess 124. The second end 134 of the communication element 126 may not be positioned in the recess 124. A portion of the communication element 126 can be positioned in the recess 124 such that the first end 132 and the second end 134 are positioned on opposite sides of the plane defined by the first side 141 of the core 106. The communication element 126 may be formed from an electrically conductive material. The communication element 126 may be formed from gold-plated copper. The recess 124 may be formed by inserted the communication element 126 into a surface of the core 106. The surface can be the first side 141. The surface can be the second side 143. The surface can be an end of the core 106 that extends from the first side 141 to the second side 143.

The data communication line 102 can be coupled to an electrically conductive member disposed at surface of a printed circuit board in electrical communication with an electrical trace supported by the printed circuit board.

A dielectric bead 128 may abut the communication element 126. The dielectric bead 128 may surround at least a portion of the communication element 126. The dielectric bead 128 may have a substantially cylindrical shape with the communication element 126 inside the cylinder. The dielectric bead 128 may exert a compressive force on the communication element 126. In some embodiments, a first end 130 of the dielectric bead 128 and the first end 132 of the communication element 126 may be substantially flush (e.g., in the transverse direction 122). In other embodiments, the communication element 126 may extend further into the recess than the dielectric bead 128. The second end 134 of the communication element 126 may extend past a second end 136 of the dielectric bead 128 (e.g., in the transverse direction 122). The first end 130 of the dielectric bead 128 and the first end 132 of the communication element 126 may be positioned in the recess 124. The dielectric bead 128 may contact the sidewall 145. The communication element 126 may be spaced from the sidewall 145 and the endwall 121. The dielectric bead 128 may be positioned between the sidewall 145 and the communication element 126. The communication element may be spaced from the core 106. The communication element 126 may be spaced from the core 106 along the transverse direction 122. The communication element 126 may be spaced from the core 106 along the longitudinal direction 112. At least a portion of the first end 130 of the dielectric bead 128 and first end 132 of the communication element 126 may be positioned in the recess 124 so that they are at a midpoint of the core 106 in the transverse direction 122. The first end 132 of the communication element may lie on the central axis of the core 106. The dielectric bead 128 and communication element 126 can extend from the first side 141 to the second side 143 of the core 106.

The first end 132 of the communication element 126 may be positioned a distance D from the endwall 121 in the longitudinal direction 112. The distance D can be approximately one tenth, one eighth, one fifth, one quarter, one third, one half, two thirds, three quarters, or seven eighths of the wavelength of a design wavelength propagating in the core 106.

The distance D may be selected depending on the desired frequency of signal propagation through the data communication line 102. For example, the desired propagating frequencies may be in the W-band, which ranges between 75 to 110 GHz. These frequencies have a free space wavelength ranging from approximately 2.7 to 4 mm. A quarter wavelength would thus range from 0.675 to 1 mm with an average value of 0.838 mm. In determining the distance D to satisfy the quarter wave condition, an effective dielectric constant for the waveguide can also be considered, since for a given frequency the wavelength in the data communication line is less than the free space wavelength. Assuming an effective dielectric constant of 1.5 yields a quarter wave distance for a W-band cable of between 0.45 and 0.67 mm. The distance D of the connector 100 may be chosen so that it falls within this range. The example of the W-band frequency range is exemplary only and this disclosure is not limited to operation in the W-band. Lower frequency bands would use proportionally longer values for D and higher frequency bands would use a proportionally smaller values of D. The cross-sectional size of the data communication line 102 can be influences by the frequency of the signal that will be transmitted. Lower frequency bands would use proportionally larger cross-sections and higher frequency bands would use proportionally smaller cross-sections.

The connector 100 can include a plug 111 adapted to couple to the body 114. The body 114 may include a hole to receive a portion of the plug 111. In some embodiments, the plug 111 is press fit into the opening in the body 114. The opening may include threads that mate with threads on an outer surface of the plug 111. The plug 111 may have a hole to accept the dielectric bead 128 and the communication element 126. The plug 111 can include a first portion having a first cross-sectional diameter and a second section having a second cross-sectional diameter. The second cross-sectional diameter may be larger than the first cross-sectional diameter. A shoulder 140 may define the boundary between the first portion and the second portion. A part of the first portion of the plug 111 may be received by the body 114. A nut 138 may include an opening such that the first portion of the plug 111 extends through the opening. The shoulder 140 of the plug 111 can abut an endwall of the nut 138. The endwall of the nut 138 can be positioned between the shoulder 140 and the body 114. In other embodiments, the body 114 and plug 111 may be a monolithic element and the nut 138 may be held in place by a snap ring within a groove (not shown) on the plug 111.

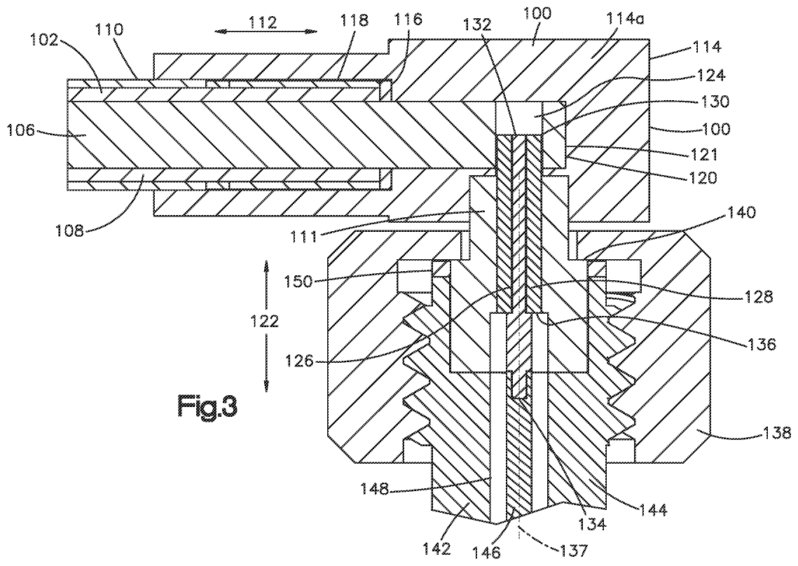

Referring to FIG. 3, the connector 100 can be mated to a jack 142. The jack 142 can be adapted to propagate an electromagnetic signal. The jack 142 can be configured to receive the electromagnetic signal from the communication element 126 and propagate the electromagnetic signal to a substrate (e.g., PCB). The jack 142 may include an outer body 144 with at least a portion of the outer body 144 being threaded to threadedly engage with the nut 138. The nut 138 may be used to secure the connector 100 to the jack 142. Jack 142 may have a central hole that extends along a central axis 137. The central axis 137 may be parallel to the second opening central axis 133. The central axis 137 may be coaxial with the second opening central axis 133. The central axis 137 may be transverse to the second opening central axis 133. The central axis 137 may be perpendicular to the opening central axis 199. The central axis 137 may be oriented in the transverse direction 122. A conductor 146 may be positioned within the central hole. An insulator 148 may also be positioned within the central hole. The insulator 148 can be an electrical insulator. The insulator 148 can be manufactured from a dielectric material. The conductor 146 may have a conductor opening at an end adjacent to the connector 100. In some embodiments, the conductor opening extends from a first side of the conductor 146 to a second side opposite the first side. In other embodiments, the conductor opening extends from the first side toward the second side but stops before reaching the second side. The conductor opening may be sized to accept the second end 134 of the communication element 126. The second end 134 of the communication element 126 may fit into the conductor 146. The second end 134 of the communication element 126 may make electrical contact with the conductor 146 when the connector 100 is mated with the jack 142. An optional gasket 150 may be situated between the second body element 114a and the outer body 144 to provide an environmental seal to isolate the communication element 126 and conductor 146 from the environment.

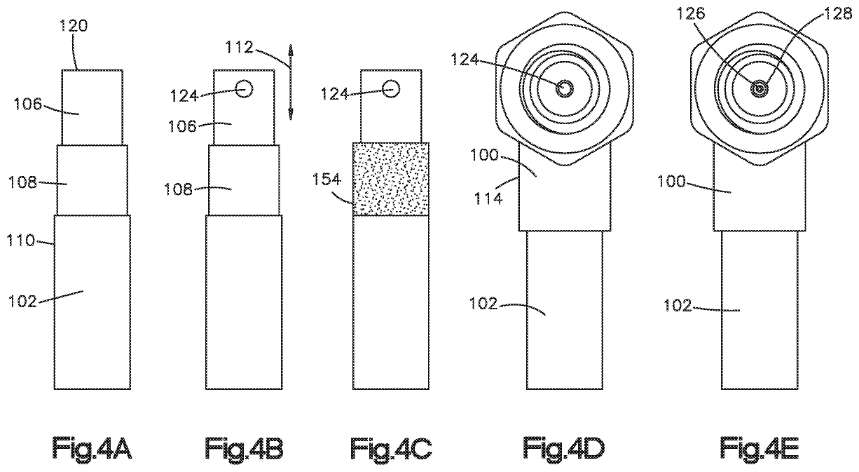

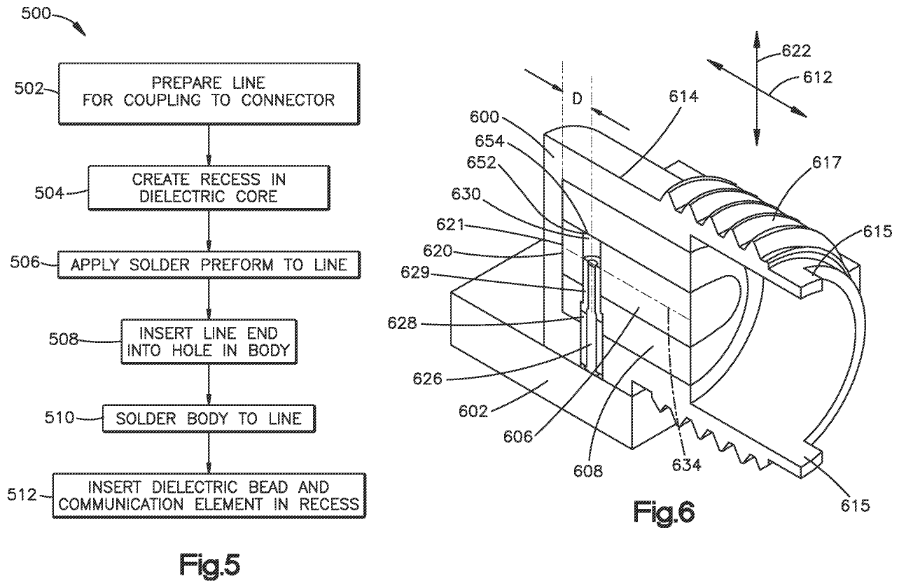

FIGS. 4A-4E show various processing steps used to produce the connector 100. FIG. 5 is a flow chart 500 that describes the various processing steps depicted in FIGS. 4A-4E. Assembly of the connector 100 may begin at step 502 in which the data communication line 102 is prepared for coupling to the connector 100. Preparing the data communication line 102 can include exposing a portion of the ground shield 108. Preparing the data communication line 102 can include exposing a portion of the core 106. In some embodiments, the jacket 110 may be scored around a perimeter of the line 102 and a section of the jacket 110 stripped back to expose the ground shield 108. In other embodiments, the jacket 110 may be cut by laser machining. A section of the ground shield 108 may be similarly removed (e.g., via scoring or laser machining) to expose a section of the core 106. Thus, a portion of both the core 106 and ground shield 108 are exposed. The ground shield 108 may be tinned to prepare the ground shield 108 for soldering in a subsequent processing step.

In step 504, the recess 124 may be formed in the core 106. The recess 124 may be formed, for example, by drilling, laser machining, or chemical etching. In some embodiments, the recess 124 is formed by inserting a communication element 126 into the core 106. The recess 124 may have a depth that is at least one half of the height of the core 106. FIG. 4B shows the data communication line 102 with the recess 124. In step 506, solder may be applied as a solder preform 154 to the exposed portion of the ground shield 108. The solder preform 154 can wrap around the perimeter of the ground shield 108. The solder preform 154 can be positioned on an exposed longitudinal end face of the ground shield 108. The preform 154 can wrap around the perimeter of the ground shield 108 and be positioned on an exposed longitudinal end face of the ground shield 108. FIG. 4C shows the data communication line 102 with the recess 124 and solder preform 154. In step 508, the prepared line 102 depicted in FIG. 4C may be inserted into the first opening 123 in the body 114 of the connector 100. In step 510, the connector 100 may be soldered into the body 114 by heating the connector 100 and data communication line 102 to melt the solder preform 154. The connector 100 and the body 114 can then be cooled to solidify the solder 118 forming an electrical and mechanical connection between the ground shield 108 of the line 102 and the body 114. The solder may fill any gaps between the ground shield 108 and body 114. The resultant assembly is shown in FIG. 4D. In step 512, the communication element 126 may be inserted into the recess 124. In some embodiments, the dielectric bead 128 is also inserted into the recess 124. In other embodiments, only the communication element 126 is inserted into the recess 124. The communication element 126 may extend into the recess 124 further than the dielectric bead 128. The dielectric bead 128 may be press fit into the recess 124. Alternatively, the dielectric bead 128 may be part of a subassembly that is secured to the body 114. FIG. 4E shows the connector 100 fixed to the data communication line 102.

The connector 100 and the assembly method thereof described above may provide a data communication line 102 with a constant core and ground shield profile to the end of the line, where the data communication line 102 is electrically shorted by the endwall 121 of the body 114. Such a design can eliminate multiple, tuned steps in the signal path, since there is a direct connection between the coaxial structure of the jack 142 and the data communication line 102. The data signal may be directly injected into the data communication line 102 by the communication element 126. the dielectric bead 128 and communication element 126 may act as a pin to prevent movement of the core 106 within the connector 100, which improves the interconnection signal integrity consistency. The orientation of the opening central axis 119 relative to the second opening central axis 133 can provide a more compact design compared to traditional high frequency micro coax cables with straight interconnection configurations. the connector 100 may be compatible with widely used industry standard board connector. As such, the connector may be used as a drop-in replacement for traditional micro coax cables. The solder preform surrounding the ground shield 108 may fill any surface irregularities in the ground shield 108. The irregularities may be manufacturing artifacts or may result from removal of the jacket 110 or a portion of ground shield 108.

The connector 100 may be placed on both ends of the data communication line 102. In this arrangement, the data communication line 102 allows the interconnection between two jacks 104 with the single data communication line 102. This arrangement may be described as a method of transmitting an electromagnetic signal between two opposing ends of a data communication line using two communication elements 126 at opposed ends of the data communication line.

Referring to FIG. 6 a connector 600 may be similar to connector 100 depicted in FIGS. 1-5, however, connector 600 may be fixedly mounted on a substrate 602, such as a printed circuit board. A communication line 102 may then be butted up against an end of the connector 600. The connector 600 may include a body 614, a ground shield insert 608, and a core 606. The core 606 may be a solid, a foam with an irregular pattern of small voids, or a tube that may have some internal structure (e.g., a void that extends the length of the core 606). In some embodiments, the core 606 may include two or more voids that extend the length of the core 606. The core 606 may be formed from a dielectric material.

One or both of the ground shield insert 608 and body 614 can be electrically conductive. In some embodiments, the ground shield insert 608 and body 614 may be a monolithic construct. In other embodiments, the ground shield insert 608 and body 614 may be separate elements that are coupled together. The core 606 may include a first end 620 and a second end spaced from the first end along a core axis 634. The first end 620 of the core 606 may extend to an endwall 621 of the body 614. A cross-section of the core 606 perpendicular to the core axis 634 may have an oval shape. The core 606 may have a recess 652 with a recess longitudinal axis 654 that is transverse to the core axis 634. The recess longitudinal axis 654 may be perpendicular to the core axis 634. The recess longitudinal axis 654 may intersect the core axis 634 at an angle of about 1 degree to about 15 degrees, about 15 degrees to about 30 degrees, about 30 degrees to about 45 degrees, about 45 degrees to about 60 degrees, about 60 degrees to about 75 degrees, or about 70 degrees to about 90 degrees. The recess 652 may be a through hole (as shown in FIG. 6). In other embodiments, the recess 652 may be a blind hole.

The recess 652 may be spaced from the endwall 621 of the body 614 by a distance D. Specifically, a center of the recess 652 may be spaced by a distance D from the endwall 621. The distance D may be chosen so that it is approximately one tenth, one eighth, one fifth, one quarter, one third, one half, two thirds, three quarters, or seven eighths of a design wavelength for signals propagating in the core 606. In the previous example of a W-band design frequency range, the distance D may be chosen so that it lies between 0.45 and 0.67 mm.

The recess 652 may be aligned with a clearance hole 629 in the ground shield insert 608. A communication element 626 may extend through the clearance hole 629 and into the recess 652. The communication element 626 may be an antenna. The communication element 626 may be centered in the recess 652. Thus, the communication element 626 may be spaced a distance D from the endwall 621. A dielectric bead 628 may surround the communication element 626. A first end 630 of the communication element may be positioned in the recess 652. The first end 630 may be positioned in the recess 652 near a mid-point of the core 606 in a transverse direction 622. The transverse direction 622 may be perpendicular to the core axis 634. For example, the first end 630 may terminate at a distance within ±10%, ±20%, or ±30% of the mid-point of the core 606 in a transverse direction 622.

The body 614 may have outer threads 617 arranged to threadedly engage a nut at the end of a communication line (not shown in FIG. 6). The body 614 may also have an orientation projection 615 that extends from the body 614 in a substantially longitudinal direction 612. The longitudinal direction may be parallel to the core axis 634. The body 614 may have two orientation projections 615 as shown in FIG. 6. The orientation projections may help align a dielectric core in a mating data communication line with the core 606 in the connector 600. The orientation projections 615 may engage a corresponding feature on the data communication line such that the data communication line is accurately aligned with the connector 600.

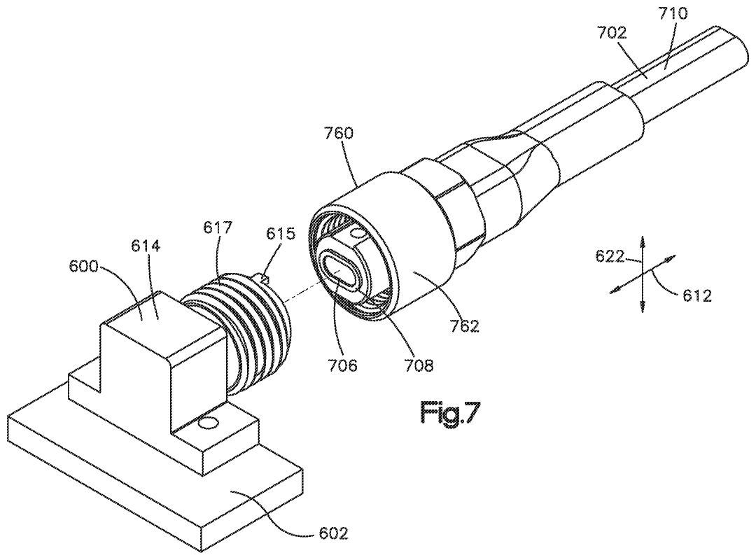

Referring to FIG. 7, the connector 600 may be adapted to couple to a mating data communication line 702. The data communication line 702 may have a core 706, a ground shield 708, and a jacket 710. A cross-sectional shape of the core 706 may be substantially similar to the cross-sectional shape and internal structure of the core 606 in the connector 600. The similar cross-sectional shapes can allow the internal elements (e.g., core and ground shield) to align with each other when the data communication line 702 is mated to the connector 600. The core 706 may be a solid core or a foam core, consisting of random small voids dispersed throughout the core 706. The core 706 may include two or more voids that extend the length of the core 706. The core 706 may also be formed by a longitudinally extended dielectric structure having a substantially uniform cross-section along its length similar to core 106. The core 706 may be surrounded by a ground shield 708. A waveguide can include a first portion and a second portion detachably coupled to the first portion. The first portion can be the core 606. The second portion can be the core 706. The first portion can be devoid of a ground shield. An antenna can penetrate a surface of the waveguide. The first portion can be carried by the connector 600. The second portion can be carried by the data communication line 702 or connector 600. The data communication line 702 or data communication connector or connector 600.

A coupling assembly 760 can be coupled to an end of the data communication line 702. The coupling assembly 760 can be adapted to couple the data communication line 702 to the connector 600. The coupling assembly 760 may include a nut 762 that is arranged to engage with the threads 617 of the connector 600 when the two elements are mated. The coupling assembly 760 may have alignment features (not shown in FIG. 7) arranged to engage with the orientation projections 615 when the data communication line 702 is mated with the connector 600. Engagement of the alignment features with the orientation projections 615 may the core 606 of the connector 600 with the core 706 of the data communication line 702. The data communication line 702 can be mated to the connector 600 by positioning the coupling assembly 760 on to the connector 600 threadedly engaging the nut 762 with the outer threads 617 of the body 614.

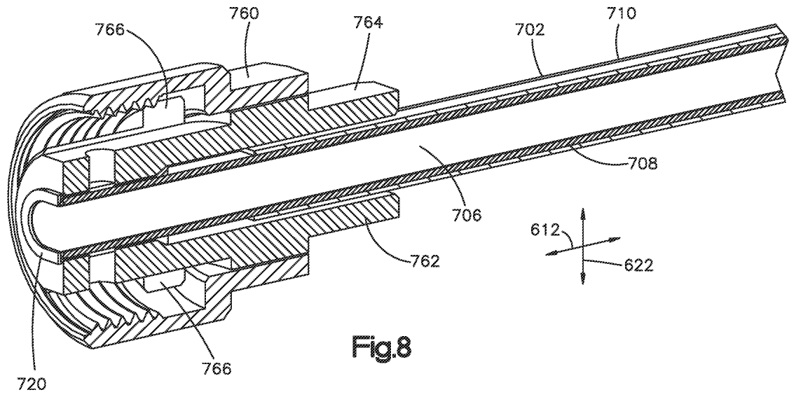

Referring to FIG. 8, one or both of the core 706 and ground shield 708 may terminate at the line end 720. The core 706 and ground shield 708 may define a substantially flat interface in the transverse direction 622 at the line end 720. An alignment ferrule 764 may be coupled to the ground shield 708. In some embodiments, the alignment ferrule 764 is fixed to the ground shield 708. The alignment ferrule 764 may be fixed to the ground shield 708 by solder.

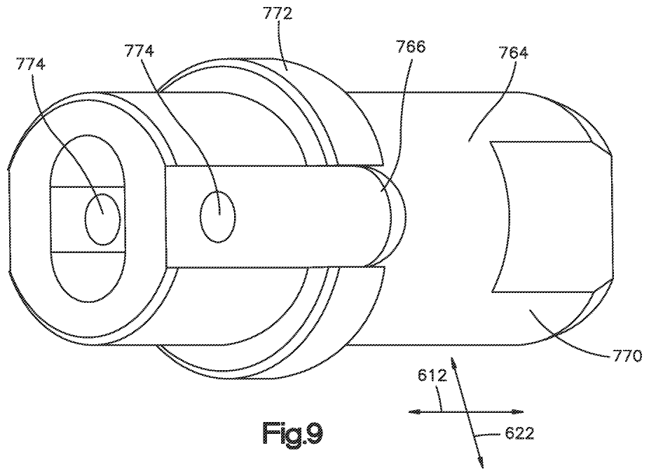

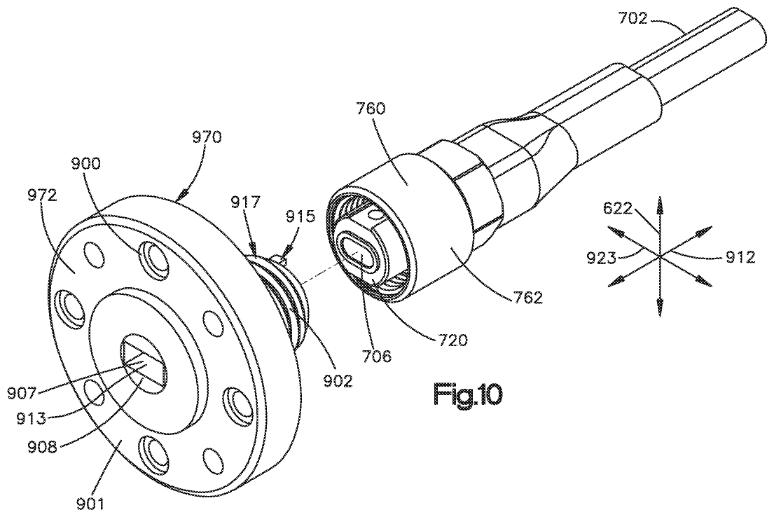

Referring to FIG. 9, the alignment ferrule 764 may include a ferrule body 770. The ferrule body 770 may include a channel sized and shaped to receive the jacket 710, ground shield 708, and core 706. A protrusion 772 may be coupled to the ferrule body 770. The protrusion 772 and ferrule body 770 may be a monolithic construct. The protrusion 772 may extend radially outward from the ferrule body 770. The protrusion 772 may extend around a perimeter of the ferrule body 770. At least one cut out 766 may be formed in the protrusion 772. The cut out 766 may be configured to engage with the orientation projection 615 of the connector 600 when the data communication line 702 is mated with the connector 600. The number of cut outs 766 may correspond to the number of orientation projections 615. The orientation projection 615 and cut out 766 may be shaped and positioned such that the ferrule body 770 couples to the connector 600 in a single orientation to ensure proper alignment of the core 606 with the core 706.

The ferrule body 770 may also include one or more apertures 774. The aperture 774 may extend through a sidewall of the ferrule body 770. There may be two apertures 774 aligned along the transverse direction 622. The apertures 774 may be aligned with the cut outs 766 in the protrusion 772. The apertures 774 may be elongated along the longitudinal direction 612. Solder may be dispensed through the apertures 774 to the underlying ground shield 708 (not shown in FIG. 9) during assembly of the coupling assembly 760. Additionally, the apertures 774 may be used as observation ports to validate solder integrity during assembly.

The coupling assembly 760 may allow the core 706, ground shield 708, and alignment ferrule 764 to form a substantially planar face at the line end 720. This may allow the data communication line 702 to be butt coupled with an adjacent element, such as the connector 600. Signal integrity can be maintained through the interconnection by aligning the core 706 and ground shield 708 with the core 606 and ground shield insert 608. This type of coupling may be employed for butt coupling of optical fibers for optical communication systems.

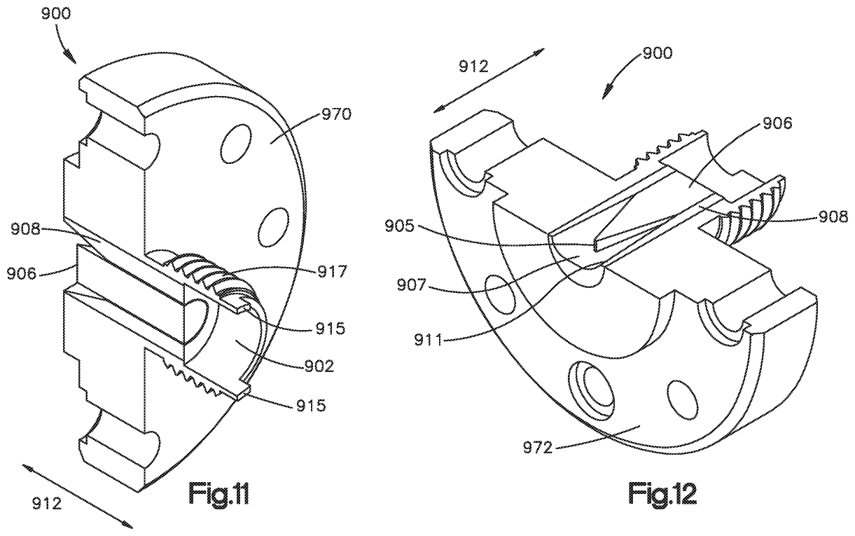

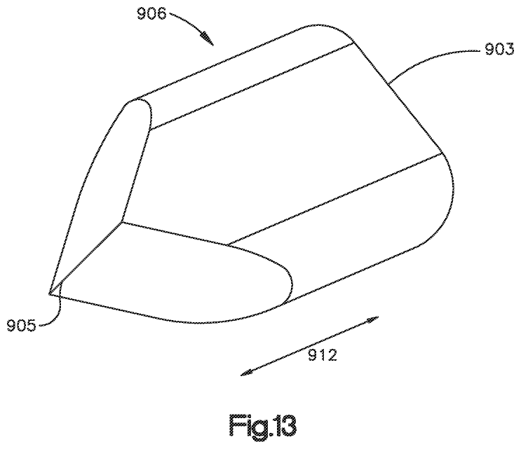

The coupling assembly 760 may be mated to connector 600 but could also be mated with a wide variety of different elements. Referring to FIGS. 10-12, an adaptor 900 may be mated to the coupling assembly 760. The adaptor 900 may be used to transition between the data communication line 702 and a waveguide for a signal propagating in a longitudinal direction 912. The waveguide can be a tube. The waveguide can be a metal tube. The waveguide can be a hollow metal tube. The waveguide can be adapted for use with millimeter-wave electrical systems. The adaptor 900 may include a body 902 sized and shaped to be engaged by the coupling assembly 760. A flange 901 may extend from the body 902. The flange 901 may extend radially outwardly from the body 902. The flange 901 may be perpendicular to the body 902. The flange 901 may have a circular shape when viewed in a plane defined by the transverse direction 622 and the lateral direction 923. The lateral direction 923 can be perpendicular to each of the longitudinal direction 912 and the transverse direction 622. The flange 901 may include an opening 913 that extends from a first side 970 of the flange 901 toward a second side 972 of the flange 901 opposite the first side 970. The body 902 may be extend from the first side 970 of the flange 901. The opening 913 may extend through each of the flange 901 and the body 902. The opening 913 may be substantially centered on the flange 901 in a plane including the lateral direction 923 and the transverse direction 622.

A shield plug 908 may be positioned in the opening 913. The shield plug 908 may be removably positioned within the opening 913. The shield plug 908 may include a sidewall 911 defining a channel 907. The shield plug 908 may define a waveguide. The shield plug 908 may define a tube waveguide. The shield plug 908 may define a metal tube waveguide. The shield plug 908 may define a hollow metal tube waveguide. The adaptor 900 may define an interface between a data communication line 702 and a standard hollow metal tube waveguide. The body 902 may include threads 917 adapted to threadedly engage the coupling assembly 760. An orientation projection 915 may extend from the body 902 to engage the cut out 766 on the ferrule body 770. The orientation projection 915 can help align the core 706 with the shield plug 908.

An insert 906 may be positioned within the channel 907 of the shield plug 908. The insert 906 and shield plug 908 may form an insert assembly. The insert 906 can be a dielectric insert. In some embodiments, the insert 906 is removably positioned within the channel 907. In other embodiments, the insert 906 is fixed within the channel 907. The channel 907 may have a rectangular or ovular cross-sectional shape. The insert 906 may have a rectangular cross-sectional shape. The insert 906 may have an ovular cross-sectional shape. The insert 906 can include a first end 903 and a second end 905 spaced from the first end 903 in the longitudinal direction 912. The first end 903 of the insert 906 may be coplanar with an end of the shield plug 908 when the insert is within the channel 907. The second end 905 of the insert 906 may be spaced from a second end of the shield plug 908 in the longitudinal direction 912 when the insert 906 is within the channel 907. The second end 905 of the insert 906 may be spaced from a second side 972 of the flange 901 in the longitudinal direction 912. The insert 906 may include a length in the longitudinal direction that is less than a length of the shield plug 908 in the longitudinal direction. The insert 906 can have a solid core, a hollow core, or a foam core, consisting of random small voids dispersed throughout the insert 906. The insert 906 may be a longitudinally extended dielectric structure with an internal void. The insert 906 can include two, three, four, five, or six voids. In some embodiments, the insert 906 may include two or more voids that extend the length of the insert 906 in the longitudinal direction.

One or both of the insert 906 and sidewall 911 of the shield plug 908 may be tapered along the longitudinal direction 912. The insert 906 may be tapered inwardly. The insert 906 may be tapered inwardly so that it comes to a point or line at the second end 905. The sidewall 911 of the shield plug 908 may taper outwardly adjacent to the second side 972 of the flange 901. The taper of the sidewall 911 may provide the second end of the channel 907 with a size and shape that matches connection standards for hollow metal tube waveguides. The gradual transition of the channel shape and size may allow an electromagnetic signal propagating through the channel 907 to have an adiabatic transition in mode size. In a region where the dielectric insert 906 has a constant cross-section in a plane perpendicular to the longitudinal direction, the channel 907 may have a constant size.

Referring to FIG. 13, the insert 906 may be a longitudinally extended dielectric core that gradually tapers along the longitudinal direction 912. The insert 906 may include a first a section with a uniform cross-sectional shape along its length in the longitudinal direction. The insert 906 may include a second a section with a tapering cross-section along its length in the longitudinal direction. The first end 903 may have a dielectric core substantially similar (e.g., size and shape) to the core 706 in the data communication line 702 (see FIG. 10). The second end 905 may taper inwardly along the longitudinal direction 912 from a first width in the lateral direction 923 to a second width in the lateral direction 923. The second width may be about 50%, about 25%, about 15%, about 10%, about 5%, about 1%, about 50% to about 25%, about 25% to about 15%, about 15% to about 10%, about 10% to about 5%, or about 5% to about 1% of the first width. The insert 906 may be symmetrically tapered about a centerline of the insert 906 that bisects a cross-section of the dielectric insert 906 at the first end 903. The taper may be a substantially adiabatic taper. An adiabatic taper can minimize propagation loss and reflection in the transition between a hollow metal tube waveguide and the data communication line 702. In some embodiments, the insert 906 has a tubular structure with a central web separating two longitudinally extending voids within an oval tube. It should be appreciated that the structural details of the dielectric insert 906 are not so limited. The insert 906 may be formed from a solid dielectric, a foam dielectric, or a tubular dielectric with a different internal structure than that depicted in FIG. 13.

The adaptor flange 901 may be configured to have a waveguide structure that transitions from a metallic dielectric waveguide on the first side 970 of the flange 901 to a hollow metal tube waveguide on the second side 972 of the flange 901. The change in the internal structure may be gradual to reduce propagation loss and reflection for a propagating electromagnetic signal. The insert 906 coupled to shield plug 908 may include a first end that defines a metallic dielectric waveguide and a second end that defines a hollow metal tube waveguide.

The data communication line 702 can be mated on the first side 970 of the adaptor 900 by butt coupling the data communication line 702 to the first end 903 of the insert 906. A hollow metal tube waveguide may be butt coupled to the channel 907 on the second side 972 of the adaptor 900. The adaptor 900 may provide an interconnection between a hollow metal tube waveguide and metallic dielectric waveguide cable.

The term substantially has been used in the description of some elements of the disclosure. In this context substantially generally means within manufacturing tolerances. For example, angular orientation tolerances may be within ±0.5°, ±1° or ±2°. Similarly, a distance tolerance may have some variance from a design value, such as ±0.001, ±0.005, or ±0.010, inches.

In the embodiments described above various elements such as, but not limited to, the body 114, the ground shield 108, the ground shield insert 608, and the shield plug 908 have been described as being electrically conductive. This may be achieved by manufacturing these various elements from metal or plastics with an electrically conductive coating in place of a solid metal element. In the frequency range from 10 GHz to 300 GHz a signal penetration depth or skin depth is very small. For example, at the E-Band (55-75 GHz) the skin depth is approximately 2 microns. By using a coating thickness greater than the skin depth, a propagating signal may be carried within the thickness of the electrically conductive coating on inner surfaces of a metallic dielectric waveguide. As such, a propagating signal may be confined within the electrically conductive coating and bulk plastic forming any of the above-mentioned elements will not impact signal propagation.

It should be appreciated that the illustrations and discussions of the embodiments shown in the figures are for exemplary purposes only and should not be construed limiting the disclosure. One skilled in the art will appreciate that the present disclosure contemplates various embodiments. Additionally, it should be understood that the concepts described above with the above-described embodiments may be employed alone or in combination with any of the other embodiments described above. It should be further appreciated that the various alternative embodiments described above with respect to one illustrated embodiment can apply to all embodiments as described herein, unless otherwise indicated.

Unless explicitly stated otherwise, each numerical value and range in the present disclosure should be interpreted as being approximate as if the word “about” or “approximately” preceded the value of the value or range. The term “about” or “approximately” when referring to a numerical value can mean within 1%, 2%, 3%, 4%, 5%, 6%, 7%, 8%, 9%, or 10% of the stated value.

1. A data communication connector comprising:
a dielectric waveguide that is elongate along a central axis; and
a recess in the dielectric waveguide that is configured to receive at least a portion of an antenna.

2. The data communication connector of claim 1, wherein the dielectric waveguide includes a first side and a second side spaced from the first side along a transverse direction that is angularly offset with respect to the central axis, and wherein the recess extends from the first side toward the second side.

3. (canceled)

4. (canceled)

5. The data communication connector of claim 2, wherein the waveguide defines an outer perimeter that is discontinuous at the first side so as to define first and second terminal ends of the outer perimeter that lie on a plane defined by the first side.

6. The data communication connector of claim 5, wherein the recess includes a first end and a second end spaced from the first end along a recess axis such that the first and second ends are disposed on opposite sides of the plane.

7. The data communication connector of claim 6, wherein the recess extends from the first side to the second side of the dielectric waveguide so as to define a through hole.

8.-10. (canceled)

11. The data communication connector of claim 6, wherein the recess axis intersects the central axis at an angle of about 75 degrees to about 105 degrees.

12.-23. (canceled)

24. The data communication connector of claim 5, further comprising an antenna, wherein a portion of the antenna is positioned in the recess.

25. The data communication connector of claim 24, wherein at least a portion of the antenna is positioned within the recess such that the antenna crosses the plane defined by the first side.

26.-36. (canceled)

37. The data communication connector of claim 1, further comprising a dielectric core of the dielectric waveguide; and
a ground shield that envelops a first portion of the dielectric core.

38. (canceled)

39. The data communication connector of claim 37, wherein the ground shield does not envelop a second portion of the dielectric core.

40. (canceled)

41. (canceled)

42. The data communication connector of claim 1, wherein the dielectric waveguide is coupled to an electrically conductive member disposed at surface of a printed circuit board in electrical communication with an electrical trace supported by the printed circuit board.

43. An interconnection system comprising:
the data communication connector of claim 1; and
a jack configured to be fixedly mounted to a substrate.

44.-79. (canceled)

80. A method of transmitting an electromagnetic signal through a data communication line having a first end and opposed second end, the method comprising:
sending the electromagnetic signal through a first antenna;
propagating the electromagnetic signal through the data communication line; and
receiving the electromagnetic signal at a second antenna.

81. The method of claim 80, wherein the data communication line is a metallic dielectric waveguide cable.

82. The method of claim 80, wherein the first antenna is located at the first end of a flexible, elongate metallic dielectric waveguide cable.

83. (canceled)

84. (canceled)

85. The method of claim 80, further comprising inserting a portion of the first antenna in a first recess in the dielectric core.

86.-88. (canceled)

89. A waveguide comprising:
a first portion; and
a second portion removably butt-coupled to the first portion.

90. The waveguide of claim 89, wherein the first portion is devoid of a ground shield.

91. The waveguide of claim 89, further comprising an antenna that penetrates a surface of the waveguide.

92.-99. (canceled)
